(19) United States
(12) Patent Application Publication
(10) Pub. No.: US 2023/0377280 A1
(43) Pub. Date: Nov. 23, 2023

(54) SYSTEM AND METHOD FOR RENDERING VIRTUAL INTERACTIONS OF AN IMMERSIVE REALITY-VIRTUALITY CONTINUUM-BASED OBJECT AND A REAL ENVIRONMENT

(71) Applicant: Alon MELCHNER, Rosh Haayin (IL)

(72) Inventor: Alon MELCHNER, Rosh Haayin (IL)

(21) Appl. No.: 18/011,661

(22) PCT Filed: Jun. 22, 2021
(86) PCT No.: PCT/IL2021/050761

§ 371 Date: Dec. 20, 2022

Related U.S. Application Data
(60) Provisional application No. 63/042,171, filed on Jun. 22, 2020.

(51) Int. Cl. G06T 19/00; G06V 10/25; G06V 20/20

(52) U.S. Cl. CPC G06T 19/006; G06V 10/25; G06V 20/20

(57) ABSTRACT

A computer-based system for rendering a virtual reaction in an XR scene comprising a virtual object in a real environment. The system comprises a sensor module that detects physical properties in a real environment; an environment analysis module that computes environment parameters of the real environment as a function of the physical properties; a reaction module that computes parameters of a virtual reaction of a virtual object overlaid on the real environment, as a function of the environment parameters; and an output module that presents a perception, of the virtual object and the real environment, in accordance with the reaction parameters. The virtual object thereby appears as a real object, form, life form, or simple static object existing in and interacting with real environment.

### RELATED APPLICATION

International application PCT/IL2018/050813, entitled “A Method for Placing, Tracking and Presenting Immersive Reality-Virtuality Continuum-Based Environment with IoT and/or Other Sensors instead of Camera or Visual Processing and Methods Thereof” is incorporated herein in its entirety.

### FIELD OF THE INVENTION

The present invention is in the field of extended reality, and in particular relates to a method and system for rendering a reaction of an immersive reality-virtuality continuum-based object to a real environment.

### BACKGROUND OF THE INVENTION

Virtual, augmented, and mixed reality environments are generated, in part, by computer vision analysis of data in an environment. Virtual, augmented, or mixed realities generally refer to altering a view of reality. Artificial information about the 3D shape (spatial mapping) of the real environment can be overlaid over a view of the real environment. The artificial information can be interactive or otherwise manipulable, providing a user of such information with an altered, and often enhanced, perception of reality.

Currently, virtual, augmented or mixed reality environments—collectively referred to as extended reality (XR)—are placed, mixed and tracked with respect to a real environment, which is typically imaged with 2D or 3D cameras. Such coordination of a real and XR environments can be implemented using visual/digital processing of the environment, an image target, computer vision, and/or simultaneous localization and mapping (SLAM); with the aim of implementing a process that determines where and how to visualize 3D XR imagery. Frequent updating of the processing is needed in order to create intuitive, realistic mixing of the virtual and real environments, entailing constant processing of the visual data from visual sensors like cameras, calculating vectors (parameters) of the 3D environment, and placing the virtual environment according to shape information (like walls, barriers, floor) to an immersive reality-virtuality continuum-based environment.

See-thru head-mount displays like glasses or contact lenses enable a user to see his/her real environment thru the glasses, they need to render the virtual environments on the lens or in front of the user to combine and mix with the real environments. They employ a camera or other sensor(s) to provide the environment 3D shape information (like walls, barriers, floor) to an immersive reality-virtuality continuum-based environment.

### SUMMARY OF THE INVENTION

An aspect of the present invention relates to collecting a new type of information from the environment processing and analysis to realistically update virtual environments according to the real environment material and surface it is placed in, on, and/or near as layers on see-through devices, camera rendered environments, mobile devices, holograms, smart-glasses, projection screens, or any means of mixing virtual and real environments.

An aspect of the present invention relates to different environments, surfaces, and/or materials and their different visual reactions and updates that affects the virtual environments accordingly. For example, if a virtual dog walks near a real lake, the present invention provides a perception that the virtual dog can drink from the lake because both logics are connected. If placed in the lake, the virtual dog appears to swim, with part of his body sunken, unlike the present technology where the virtual dog appears to walk on water. Other examples: placing a virtual broken egg on a hot surface will transform it to a sunny side up egg; placing a virtual man naked in snow causes him to shiver.

An aspect of the present invention relates to sound reactions of different environments, surface, and/or materials and their and updates that affects the virtual environments accordingly. For example: a virtual object walking on a real metal surface makes metallic sounds; swimming in real water makes resulting water-splashing sounds.

Placement of a virtual environment on top of a real environment with this invention may also use AI general abilities, visual processing, AI visual processing, sound processing, material identification, temperature processing, smell processing, transmitted information and other sensors and methods thereof that will help the virtual device understand the environment's information and transfer them to the XR content to react accordingly.

An aspect of the present invention relates to using artificial intelligence (AI) to interpret and parametrize the real environment, in preparation for determining an appropriate reaction and activating the reaction in the XR object.

The use of AI includes the ability of the AI machine to collect data, learn new behaviors, learn from experiences of essentially infinite users and adapt accordingly. A big-data provider such as IBM Watson can be employed to implement the AI function.

The placement of a virtual environment on top of a real environment with this invention may use simultaneous localization and mapping (SLAM) and/or AR technologies like Apple's ARkit, Google's ARcore, or any other future technology.

It is therefore an objective of the present invention to provide a computer-based system for rendering a virtual reaction in an XR scent comprising a virtual object in a real environment, the system comprising
a. a sensor module, configured to receive one or more physical properties from a real environment;
b. an environment analysis module, configured to compute one or more environment parameters of the real environment as a function of the physical properties; wherein the system further comprises
c. a reaction module, configured to compute one or more parameters of a virtual reaction of a virtual object in the real environment, as a function of the environment parameters; and
d. an output module, configured to present a perception, of the virtual object and the real environment, in accordance with the reaction parameters.

It is a further objective of the invention to provide the abovementioned system, wherein the sensor module comprises one or more sensors selected from a group consisting of a camera, a microphone, photodetector, smell sensor, speedometer, pedometer, thermometer, GPS locator, BLE, WiFI, an MR beacon, and any combination thereof.

It is a further objective of the invention to provide the abovementioned system, wherein the environment analysis module employs one or more techniques in a group consisting of visual processing, AI visual processing, sound processing, material identification, temperature processing, smell processing, shape-from-shading, location processing, and any combination thereof.

It is a further objective of the invention to provide the abovementioned system, wherein the virtual reaction module is further configured to locate a region of contact between the virtual object and the real environment.

It is a further objective of the invention to provide the abovementioned system, wherein the virtual reaction comprises one or more in a group consisting an image, a moving image, a sound, a smell, a touch, or any combination thereof.

It is a further objective of the invention to provide the abovementioned system, wherein the perception is presented by one or more in a group consisting of a see-through display, a camera-rendered environment displayed on a TV or computer screen, mobile devices, a projection screen, a holographic display, an acoustic speaker, AR speakers, and AR sound.

It is a further objective of the invention to provide the abovementioned system, wherein the environment analysis module and the reaction module are comprised by an AI module, the AI module further configured to optimize the computations of the environment parameters and the reaction parameters, from an aggregation of user behaviors in response to the presented perceptions.

It is a further objective of the invention to provide a computer-based AI system for rendering a virtual reaction of an immersive reality-virtuality continuum-based object (XR object) to a real environment, comprising
a. a sensor module, configured to receive one or more physical properties from a real environment;
b. an AI module, configured to
   i. compute one or more parameters of the real environment as a function of the physical properties;
wherein the AI module is further configured to
   ii. compute one or more parameters of a virtual reaction of a virtual object in the real environment as a function of the environment parameters; and
c. an output module, configured to present a perception, of the XR object and the real environment, in accordance with the reaction parameters;
   further wherein the AI module is further configured to optimize the computations of the environment parameters and the reaction parameters, from an aggregation of user behaviors in response to the presented perceptions.

It is a further objective of the invention to provide the abovementioned computer-based AI system, wherein the AI module is further configured to locate a region of contact between the virtual object and the real environment.

It is a further objective of the invention to provide the abovementioned computer-based AI system, wherein the AI module operates in a chain-reaction mode, wherein configured to repeat the computation of the real environment and the parameters of the virtual reaction, and the output module configured to accordingly adjust the perception of the XR object and the real environment.

It is a further objective of the invention to provide the abovementioned computer-based AI system, wherein the AI module is provided as one or more of an SAS, SDK, and API.

It is a further objective of the invention to provide a computer-based method for rendering a virtual reaction of an immersive reality-virtuality continuum-based object (XR object) to a real environment, comprising
a. receiving one or more physical properties from a real environment;
b. computing one or more parameters of the real environment as a function of the physical properties;
   wherein the method further comprises steps of
c. computing one or more parameters of a virtual reaction of an virtual object as a function of the environment parameters; and
d. presenting a perception, of the XR object and the real environment, in accordance with the reaction parameters.

It is a further objective of the invention to provide the abovementioned method, wherein the sensor module comprises one or more sensors selected from a group consisting of a camera, a microphone, photodetector, smell sensor, speedometer, pedometer, thermometer, GPS locator, an MR beacon, and any combination thereof.

It is a further objective of the invention to provide the abovementioned method, wherein the environment analysis module employs one or more techniques in a group consisting of visual processing, AI visual processing, sound processing, material identification, temperature processing, smell processing, shape-from-shading, location processing, and any combination thereof.

It is a further objective of the invention to provide the abovementioned method, further comprising a step of locating a region of contact between the virtual object and the real environment.

It is a further objective of the invention to provide the abovementioned method, wherein the reaction parameters comprise one or more in a group consisting an image, a moving image, a sound, a smell, a touch, or any combination thereof.

It is a further objective of the invention to provide the abovementioned method, wherein the perception is presented by one or more in a group consisting of a see-through display, a camera-rendered environment displayed on a TV or computer screen, mobile devices, a projection screen, a holographic display, and an acoustic speaker.

It is a further objective of the invention to provide the abovementioned method, further comprising a step of optimizing the computations of the environment parameters and the reaction parameters, from an aggregation of user behaviors in response to the presented perceptions.

It is a further objective of the invention to provide a computer-based AI method for rendering a virtual reaction of an immersive reality-virtuality continuum-based object (XR object) to a real environment, comprising steps of
a. receiving one or more physical properties from a real environment;
b. computing one or more parameters of the real environment as a function of the physical properties;
   wherein the method further comprises steps of
c. computing one or more parameters of a virtual reaction of a virtual object as a function of the environment parameters; and
d. presenting a perception, of the XR object and the real environment, in accordance with the reaction parameters;
   further wherein the method further comprises a step of optimizing the computations of the environment parameters and the reaction parameters, from an aggregation of user behaviors in response to the presented perceptions.

It is a further objective of the invention to provide the abovementioned computer-based AI method, further comprising a step of locating a region of contact between the virtual object and the real environment.

It is a further objective of the invention to provide the abovementioned computer-based AI method, further comprising steps of repeating the computations of the real environment and the parameters of the virtual reaction and accordingly adjusting the perception of the XR object and the real environment.

It is a further objective of the invention to provide the abovementioned computer-based AI method, wherein the steps of computing the real environment parameters and virtual reaction parameters is provided by one or more of an SAS, SDK, and API.

It is a further object of the invention to provide a non-transitory computer-readable memory (CRM) comprising instructions configured to cause one or more processors to
a. receive outputs of one or more physical properties from a real environment;
b. compute one or more parameters of the real environment as a function of the physical properties;
   wherein the instructions further cause the processors to
c. compute one or more parameters of a virtual reaction of an XR object as a function of the environment parameters; and
d. return the virtual reaction parameters;
   further wherein the instructions further causes the processors to optimize the computations of the environment parameters and the virtual reaction parameters, from an aggregation of user behaviors in response to the presented perceptions.

It is a further object of the invention to provide the abovementioned CRM, wherein the instructions are further configured to cause the processors to locate a region of contact between the virtual object and the real environment.

It is a further object of the invention to provide the abovementioned CRM, wherein the instructions are further configured to cause the processors to locate a region of contact between the virtual object and the real environment.

It is a further object of the invention to provide the abovementioned CRM, wherein the CRM is accessible as one or more of an SAS, SDK, and API.

### BRIEF DESCRIPTION OF THE FIGURES

In the following detailed description of the preferred embodiments, reference is made to the accompanying drawings that form a part hereof, and in which are shown by way of illustration

FIG. 1 is a functional block diagram of a system for rendering a virtual reaction of an immersive reality-virtuality continuum-based object (XR object) to a real environment, according to some embodiments of the present invention.

FIGS. 2A-2D each depict an example of a rendering of an XR object reacting to a real environment.

FIG. 3 is a flow diagram of a method for rendering a virtual reaction of an immersive reality-virtuality continuum-based object (XR object) to a real environment, according to some embodiments of the present invention.

### DETAILED DESCRIPTION OF THE INVENTION

“Extended reality (XR)” and “immersive reality-virtuality continuum” refers to perceivable combinations of virtual and real objects.

“Virtual reaction” or “virtual interaction” (or simply “reaction” or “interaction”) refers to a modification in the perception of an XR scene comprising a virtual object located in a real environment. The reaction is typically super-imposed (visually, aurally, or otherwise) on the real environment. The reaction may comprise a modification of the virtual object and/or a modification of the real environment.

“Environment parameter” is an attribute of a real environment affecting the attributes of a virtual interaction.

“Virtual-object interaction parameter” is an attribute of a virtual object affecting the attributes of a virtual interaction.

A key aspect of the present invention refers to the collection, processing and interpretation of the surfaces, materials and matter properties and parameters as a physical and realistic interpretation. The matter may for example wet, dry, woody, sandy, muddy, fluid, flowing, solid, granular, friable, velvety, granite-like, gritty, nebulous, gas, hard, soft, texturized, and/or yielding. The matter may be hot, warm, cold, icy, translucent, and/or opaque. The present invention provides a physical and realistic interpretation of the real material encountered by the virtual object rather than the just the physical shape. This encounter may of course be accompanied by appropriate sounds, such as the sound of water splashing, or ice breaking and the myriad of sounds that would occur in the real world.

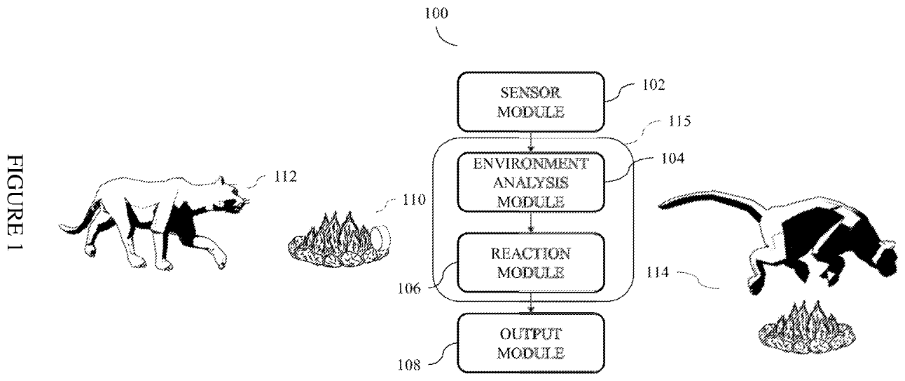

Reference is now made to FIG. 1, showing a functional block diagram of a system 100 for rendering a virtual reaction of an XR scene comprising a virtual object 112 in a real environment 110. The reaction may be a virtual response of virtual object 112 to one or more parameters of the real environment 110, such as characteristics of a surface in the real environment. The virtual reaction of virtual object 112 can involve relocation, re-orientation, motion and/or an animation of virtual object 112; and/or a sound, made by virtual object 112 interacting with real environment 110. For example, virtual object 112 can virtually be on, walk on, move into, be placed on, exist in or near, and/or interact with or near real environment 110 or an element therein, appearing as if the virtual object 112 is a real object, form, or life form or even simple static object existing in and interacting with real environment 110. A perception 114 of virtual object 112 reacting to real environment 110 is presented to a user. The user may be in proximity to real environment 110, whereby virtual object 112 with the virtual reaction is overlaid on real environment 110 (e.g., by a see-through display), or the use may be remote from real environment 110 (e.g., viewing real environment 110 via a video link).

System 100 comprises a sensor module 102, environment analysis module 104, reaction module 106, and output module 108.

Sensor module 102 is configured to sense one or more physical properties of a real environment 110. Sensor module 102 may comprise, for example, visual sensors, sound sensors, smell sensors, data transmitted sensor and any combination thereof. The sensors may be, for example, a camera, microphone, photodetector, smell sensor, speedometer, pedometer, temperature sensor, GPS locator, a radio receiver, BLE, WiFi, an MR beacon and any combination thereof.

Environment analysis module 104 computes environment parameters as a function of the physical properties sensed by sensor module 102. For example, environment analysis module 104 may use visual processing to compute a material or surface texture of an object in real environment 110. Environment analysis module 104 may use visual processing, AI visual processing, sound processing, material identification, temperature processing, smell processing, and other methods that interpret information about real environment 110 that affect a virtual reaction of virtual object 112 in real environment 110.

Reaction module 106 receives the environment parameters and computes one or more virtual interaction parameters of virtual object 112 in real environment 110. The virtual interaction parameters are computed as if virtual object 112 were a real object interacting with real environment 110. Virtual-object interaction parameters may modify some aspect of the virtual object 112 and/or real environment 110 such as virtual tread marks left by a virtual car “travelling” on a real dirt road. Virtual reaction parameters may be parameters of an image, a moving image, a 3D object, a sound, a smell, a touch, or any combination thereof.

Output module 108 presents a perception 114 of virtual object 112 in real environment 110, in accordance with the virtual reaction parameters. Perception 114 is perceived by a user as if virtual object 112 is interacting with real environment 110. Output module 108 may present the perception by means such as a see-through display, a camera-rendered environment displayed on a TV or computer screen, mobile devices, a projection screen, a holographic display, an acoustic speaker, or any combination thereof.

In the example embodiment shown, a sensor module 102 receives an image of a real fire 110. Environment analysis module 104 identifies an image of real fire 110 as a fire. Reaction module 106 determines that fire is bad for the cougar. Reaction module 106 determines that an appropriate reaction is for a “walking” virtual cougar 112 to “jump” over the fire. Reaction module 106 computes parameters of the jump (e.g., starting point, jump speed, arc height). An output module 108 displays a scene comprising virtual cougar 112 virtually jumping over real fire 110, in accordance with the jump parameters.

In some embodiments, environment analysis module 104 and reaction module 106 is implemented with an artificial intelligence (AI) module 115, which can comprise an external cloud AI system, such as IBM Watson. AI module 115 receives data about real environment 110 from sensor module 102. AI module 115 synthesizes the roles of environment analysis module 104 and reaction module 106, making a determination of how to best modify XR object 112 in response to the environment data. As output module 108 presents perceptions of a reacting XR object 112 in real environment 110, AI module 115 simultaneously receives user behavior. The user behavior may be determined by a change in environment data from sensor module 102, for example. From an aggregation of user behaviors in response to XR object reactions, AI module 115 employs a machine learning algorithm to adapt the reaction presented by output module 108 to the environment data from sensor module 104.

System 100 may work employ an AI module 115. A camera provides information as to the location of the real object. The AI module 115 analyzes where the virtual object is. The reaction module calculates the interaction of the virtual object and the real surface of the matter. AI module 115 then calculates and implements the change in a property of the virtual object that occurred because of the aforementioned interaction of the virtual object and the real surface of the matter, and the changed virtual object will now affect another real surface of matter, and will again be changed thereby. In practice, a chain reaction will have been set up, with each step affecting the next step, having been affected by the previous one.

AI module 115 may be programmed manually; for example, for an initial operation. Alternatively or in addition, AI module 115 may employ a machine-learning algorithm in order to automatically learn an appropriate interaction for each given property of real environment 110 and XR object 112, as well as updated properties as a result of each interaction. The machine-learning algorithm is configured to so learn for a dynamically varying range of the properties and interactions that could be encountered at a step of a chain reaction.

In some embodiments, access to AI module 115 is provided as a platform such as a software-as-a-service (SAS), software development kit (SDK), and/or an application program interface (API). A programmer specifies inputs comprising outputs of sensors, such video data, sound, light levels, smells, temperature, coordinates and/or a user's speed, pace, relative position and/or orientation. The programmer may also specify characteristic of a virtual object. Alternatively, the programmer may specify one or more key words and/or descriptions. AI module 115 accordingly selects a virtual object and may provide the virtual object characteristics to the programmer and/or may retain them for further computations. AI module 115 analyzes the real environment from the sensor readings and the virtual object characteristics, and then computes parameters of an appropriate virtual reaction. AI module 115 provides the virtual reaction parameters to the programmer. AI module may provide parameters of multiple possible reactions. AI module 115 may additionally provide parameters of the real environment, which can include the type of surface it sees the virtual object presently traversing and/or predicted to soon traverse. AI module 115 may update virtual reaction characteristics in the chain-reaction paradigm further described herein. The platform may further receive from the programmer behaviors of a user in response to perceptions presented in accordance with the virtual reaction parameters. The user responses may be provided to AI module 115, which may optimize computations of environment parameters and virtual reaction parameters, from an aggregation of past user behaviors in response to perceptions presented in accordance with virtual reaction parameters. In some embodiments, user responses may be required in order for the programmer to access the platform, or to access the platform for a reduced price or for free.

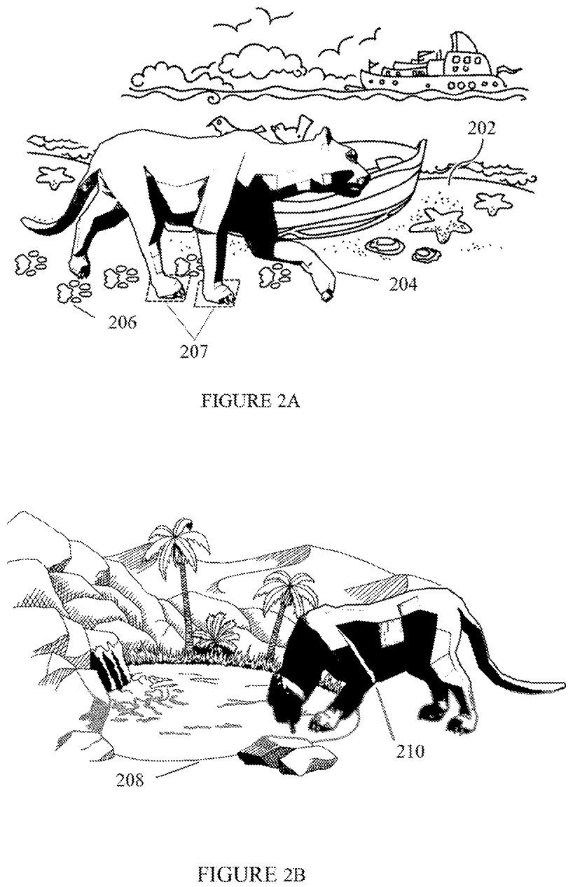

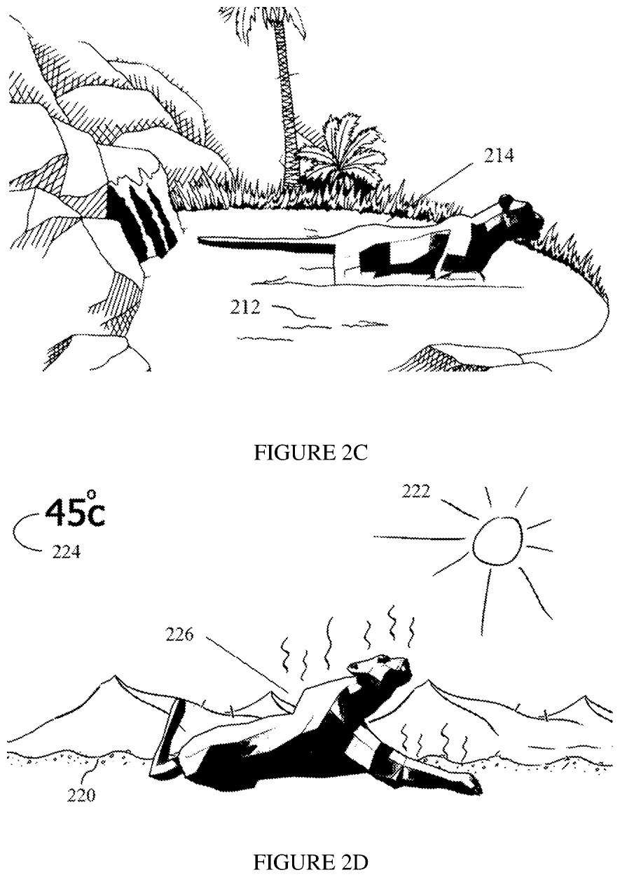

Reference is now made to FIGS. 2A-2E, showing additional examples of a virtual object reacting to a real environment.

In FIG. 2A, a sensor module 102 receives an image of a real beach 202. An environment analysis module 104 identifies an image of real beach 202 as a beach and that a ground of real beach 202 is soft. A reaction module 106 computes a virtual reaction of an XR object, a virtual walking cougar 204. In some embodiments, reaction module 106 locates one or more regions of contact 207 between the real environment and the virtual object. In this case, a region of contact 207 occurs where a virtual paw of the cougar “touches” the sand. Reaction module 106 determines that a reaction of a paw touching the sand is leaving a footprint. Reaction module 106 sends characteristics of a virtual footprint in the shape of the paw and at the location of regions of contact 207 as cougar 204 virtually walks on real beach 202. An output module 108 displays a scene comprising virtual footprints 206 of walking cougar 204 on real beach 202.

In FIG. 2B, a sensor module 102 receives an image of a real lake 208. An environment analysis module 104 computes that the image of real lake 208 represents a body of water. A reaction module 106 computes parameters a virtual reaction of a virtual cougar 210 virtually drinking from real lake 208. An output module 108 displays a scene comprising virtual cougar 210 virtually drinking from real lake 208.

FIG. 2C shows an alternative virtual reaction of a virtual cougar 214 to a real lake 212. Reaction module 106 computes parameters of a virtual reaction of virtual cougar 214 virtually walking through real lake 212. Output module 108 displays a scene comprising virtual cougar 214 virtually walking through real lake 212. Reaction module 106 and output module 108 may further compute and present sounds made by virtual cougar 214 virtually walking through real lake 212.

In FIG. 2D, a sensor module receives an image of a real desert 220 and real sun 222; and a real temperature 224 of 45° C. An environment analysis module 104 identifies the image of real desert 220 as a desert and the image of the real sun 222 as the sun, and registers real temperature 224. A reaction module 106 computes parameters of a virtual cougar 226 reacting to being in real desert 220 under real sun 222 at a real temperature 224 of 45° C., by resting in real desert 220 and sweating. An output module 108 displays a scene comprising virtual cougar 226 virtually lying in real desert 220 with animated wavy marks emanating from virtual cougar 226 representing virtual sweating.

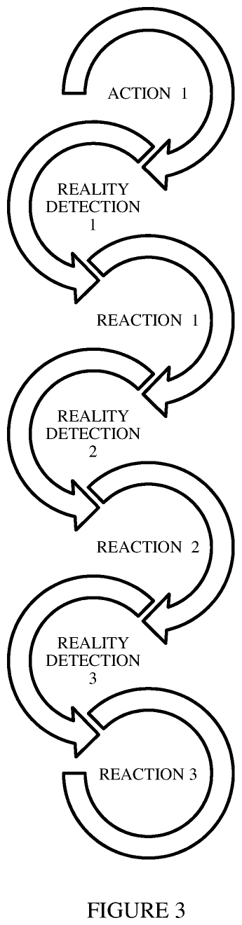

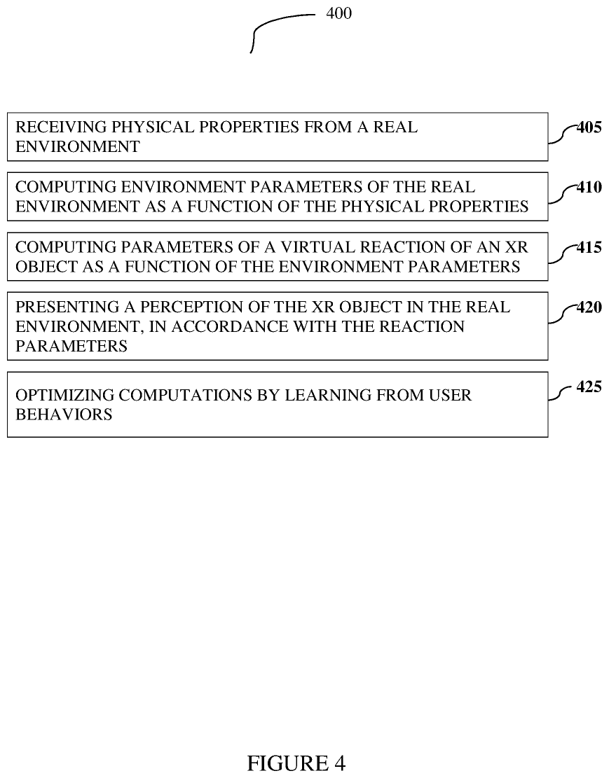

FIG. 3 shows a chain-reaction mode of operation of AI module 115 comprising a sequence of an action, reality detection, and reaction. As a non-limiting example, AI module 115 instills a virtual dog with Action 1: virtually running. In Reality Detection 1, AI module analyzes data from sensor module 102 and detects a real lake in the path of the vitual dog. As the virtual dog “runs” into the lake, in Reaction 1 AI module 115 confers on the virtual dog attributes of appearing partially submerged in the lake and of virtual wetness, such as a virtual glistening wet coat, splashing and, as the virtual wet dog continues “running” outside the real lake, the virtual wet dog has virtual water droplets “dripping” off and virtual muddy paws leaving virtual paw prints on the ground around the real lake. In Reality Detection 2, the AI module 115 recognizes a nearby real cabin. In Reaction 2, as the virtual running dog virtually runs into the real cabin. AI module 115 recognizes that the virtual wet coat will cause virtual water to “splash” virtual drops on the floor of the real cabin, and implements this reaction. In Reality Detection 3, AI module 115 recognizes that the floor of the cabin is carpeted. In Reaction 3, AI module 115 provides a virtual housemaid with a virtual wet vacuum cleaner, virtually cleaning the virtual muddy footprints from the real carpet. Actions/reactions are perceptible through output module 108, superimposed on the real environment.

Reference is now made to FIG. 4, showing a computer-based AI method 400 for rendering a virtual reaction of an immersive reality-virtuality continuum-based object (XR object) to a real environment. Method comprises steps of
a. receiving one or more physical properties from a real environment 405;
b. computing one or more parameters of the real environment as a function of the physical properties 410;
c. computing one or more parameters of a virtual reaction of an XR object as a function of the environment parameters 415;
d. presenting a perception, of the XR object and the real environment, in accordance with the virtual reaction parameters 420;

In some embodiments, method 400 further comprises a step of optimizing the computations of the environment parameters and the virtual reaction parameters, from an aggregation of user behaviors in response to the presented perceptions 425.

1.-45. (canceled)

46. A computer-based system 100 for rendering for rendering a virtual reaction in an XR scene comprising a virtual object 112 in a real environment 110, said system 100 comprising
a. a. a sensor module 102, configured to receive one or more physical properties from a real environment 110;
b. an environment analysis module 104, configured to compute one or more environment parameters of said real environment 110 as a function of said physical properties;
wherein said system 100 further comprises
c. a reaction module 106, configured to compute one or more parameters of a virtual reaction of a virtual object 112 in said real environment 110, as a function of said environment parameters; and
d. an output module 108, configured to present a perception 114, of said virtual object and said real environment, by combining the AI logic of said virtual object and the AI logic of said real environment and said virtual reaction parameters,
wherein said sensor module comprises one or more sensors selected from a group consisting of a camera, a microphone, photodetector, smell sensor, speedometer, pedometer, thermometer, GPS locator, BLE, WiFI, an MR beacon, and any combination thereof

47. The computer-based system of claim 46, wherein said environment analysis module employs one or more techniques in a group consisting of visual processing, AI visual processing, sound processing, material identification, temperature processing, smell processing, shape-from-shading, location processing, and any combination thereof.

48. The computer-based system of claim 46, wherein said virtual reaction module is further configured to locate a region of contact between said virtual object and said real environment.

49. The computer-based system of claim 46, wherein said virtual reaction comprises one or more in a group consisting of an image, a moving image, a sound, a smell, a touch, or any combination thereof.

50. The computer-based system of claim 46, wherein said output module comprises one or more in a group consisting of a see-through display, a camera-rendered environment displayed on a TV or computer screen, mobile devices, a projection screen, a holographic display, an acoustic speaker, AR speakers, and AR sound.

51. The computer-based system of claim 46, wherein said environment analysis module and said reaction module are comprised by an AI module, said AI module further configured to optimize said computations of said environment parameters and said virtual reaction parameters, from an aggregation of user behaviors in response to said presented perceptions.

52. A computer-based method 400 for rendering a virtual reaction of an immersive reality virtuality continuum-based object (XR object) to a real environment, comprising
a. receiving one or more physical properties from a real environment 405;
b. computing one or more parameters of said real environment as a function of said physical properties 410;
wherein said method 400 further comprises steps of
c. computing one or more parameters of a virtual reaction of a virtual object 112 as a function of said environment parameters by combining the AI logic of said virtual object and the AI logic of said real environment sand
d. presenting a perception, of said XR object and said real environment, in accordance with said virtual reaction parameters.

53. The method of claim 52, wherein said sensor module of claim 1 comprises one or more sensors selected from a group consisting of a camera, a microphone, photodetector, smell sensor, speedometer, pedometer, thermometer, GPS locator, an MR beacon, and any combination thereof.

54. The method of claim 52, wherein said environment analysis module of claim 1 employs one or more techniques in a group consisting of visual processing, AI visual processing, sound processing, material identification, temperature processing, smell processing, shape-from-shading, location processing, and any combination thereof.

55. The method of claim 52, further comprising a step of locating a region of contact between said virtual object and said real environment.

56. The method of claim 52, wherein said virtual reaction comprises one or more in a group consisting an image, a moving image, a sound, a smell, a touch, or any combination thereof. and said perception is presented by one or more in a group consisting of a see-through display, a camera-rendered environment displayed on a TV or computer screen, mobile devices, a projection screen, a holographic display, and an acoustic speaker.

57. The method of claim 52, further comprising steps of optimizing said computations of said environment parameters and said virtual reaction parameters, from an aggregation of user behaviors in response to said presented perceptions.

58. The method of claim 52 further comprising steps of locating a region of contact between said virtual object and said real environment.

59. The method of claim 52, further comprising steps of a chain-reaction mode, comprising repeating said computations of said real environment and said parameters of said virtual reaction and accordingly adjusting said perception of said XR object and said real environment. wherein said steps of computing said real environment parameters and virtual reaction parameters is provided one or more of an SAS, SDK, and API.

60. A non-transitory computer-readable memory (CRM) comprising instructions configured to cause one or more processors to
a. receive outputs of one or more physical properties from a real environment;
b. compute one or more parameters of said real environment as a function of said physical properties;
wherein said instructions further cause said processors to
c. computing one or more parameters of a virtual reaction of a virtual object 112 as a function of said environment parameters by combining the AI logic of said virtual object and the AI logic of said real environment and
d. return said virtual reaction parameters;
further wherein said instructions further causes said processors to optimize said computations of said environment parameters and said virtual reaction parameters, from
an aggregation of user behaviors in response to said presented perceptions.
wherein said instructions are further configured to cause said processors to locate a region of contact between said virtual object and said real environment.

61. The non-transitory computer-readable memory (CRM) of claim 60, wherein said instructions cause said processors to implement a chain-reaction mode, wherein configured to repeat said computation of said real environment and said parameters of said virtual reaction, and said output module configured to accordingly adjust said perception of said XR object and said real environment.

62. The non-transitory computer-readable memory (CRM) of claim 61 wherein said CRM is accessible as one or more of an SAS, SDK, and API.
